(19) United States
(12) Patent Application Publication
(10) Pub. No.: US 2009/0040956 A1
(43) Pub. Date: Feb. 12, 2009

(54) PACKET TRANSMISSION DEVICE AND PACKET TRANSMISSION METHOD

(75) Inventor: Kenichiro Shinoi, Kanagawa (JP)

Correspondence Address: Christensen O'Connor Johnson Kindness PLLC, 1420 5th Avenue, Suite 2800, Seattle, WA, 98101, US

(73) Assignee: MATSUSHITA ELECTRIC INDUSTRIAL CO., LTD., Kadoma-shi, Osaka (JP)

(21) Appl. No.: 11/813,995

(22) PCT Filed: Jan. 16, 2006
(86) PCT No.: PCT/JP2006/300438

§ 371 Date: Jul. 13, 2007

(30) Foreign Application Priority Data
Jan. 19, 2005 (JP) 2005-011964

(51) Int. Cl. H04H 20/71; H04W 72/12

(52) U.S. Cl. 370/312

(57) ABSTRACT

There is provided a packet transmission device capable of receiving an MBMS service packet which could not be received for level measurement of a different frequency in a mobile station device, by using the current scheduling information. In this packet transmission device, an empty section search unit (102) searches how much space exists between which services in the multi-cast transmission frame transmitted from the scheduling information to a physical channel. A retransmission packet selection unit (103) extracts a retransmission packet from the packets transmitted at the service immediately before the empty section. A packet transmission unit (104) can perform retransmission for filling the empty section.

### TECHNICAL FIELD

The present invention relates to a packet transmission apparatus and a packet transmission method provided in a base station in a CDMA (Code Division Multi Access) communication system. More particularly, the present invention relates to a packet transmission apparatus and a packet transmission method that transmit packets relating to MBMS (Multimedia Broadcast/Multicast Service).

### BACKGROUND ART

In recent years, in an effort to implement a system that provides simultaneous multi-media data services to a known or an unknown number of users in W-CDMA-scheme communication systems, the standardization project, known as 3GPP, for third generation (3G) mobile phone system specifications has taken steps toward the standardization of MBMS. The following will now explain the MBMS service packet transmission method disclosed in non-patent document 1, with reference to FIGS. 1 and 2.

FIG. 1 is a diagram showing an example configuration of a conventional packet transmission apparatus. As shown in FIG. 1, the MBMS service system is composed of a packet transmission apparatus 11, which is a base station apparatus, and a wireless control apparatus 12, which is a host apparatus, and a mobile station apparatus 13.

The packet transmission apparatus 11 is equipped with a packet transmission section 14. MBMS service (an example shown in the diagram is of three services of service A, service B, and service C) packets and scheduling information from the wireless control apparatus 12 are inputted in parallel to the packet transmission section 14. Details of packet scheduling per service are described in scheduling information (including the order for transmitting each service's packets, the timing, and length of time for transmission, and the like) of packets for each service is described in the scheduling information.

The packet transmission section 14 disposes data packets for service A, data packets for service B, and data packets for service C by time division in multicast transmission frames based on the scheduling information, or disposes scheduling information packets at a final position in the frame, and transmits that frame to the mobile station apparatus 13 using a physical channel. The following will now provide a detailed explanation with reference to FIG. 2.

FIG. 2 is a diagram to explain a conventional packet transmission method. In FIG. 2, TTI (Transmission Time Interval) is the time interval to transmit one packet. A (A1 to A9) represents the packets of service A; B (B1 to B6) represents the packets of service B; C (C1 and C2) represents the packets of service C; and S (S1, S2, S3) represents schedule information packets.

FIG. 2 shows three multicast transmission frames (a), (b) and (c). Each multicast transmission frame is composed of eighteen TTIs, and the frames from the top to the seventeenth TTI are furnished for data packets. The final TTI is furnished for the scheduling information packet S. Described using the example provided in FIG. 2, these are consecutively transmitted in order of (a), (b) and (c) over a physical channel.

Essentially, the scheduling information packet S is sent at regular intervals (described using the example of FIG. 2, at the rate of once every eighteen TTIs) on the physical channel that carries MBMS service packets. The transmission start timing and the length (the number of TTIs) of each MBMS service transmitted in the period of seventeen TTIs until the transmission of the next scheduling information packet S, are described in this scheduling information packet S.

At the multicast transmission frame (a) shown in FIG. 2, there are no data packets in the seventeen TTIs from time T=0 to time T=17, and the scheduling information packet S1 is inserted in the final position. Upon receiving scheduling information from the wireless control apparatus 12, the packet transmission section 14 reports the content of the information to the mobile station 13 as scheduling information packet S1.

It is described in the scheduling information packet S1 that, in the next multicast transmission frame (b), in the period of a length of six TTIs from time T=18, packets A1 to A6 of service A will be transmitted, that in the period of a length of three TTIs from time T=27, packets B1 to B3 of service B will be transmitted, and that in the period of a length of one TTI from time T=32, packet C1 of service C will be transmitted.

The packet transmission section 14 generates a multicast transmission frame (b) that reflects the content of the scheduling information packet S1 and transmits that to the mobile station apparatus 13. In other words, with this multicast transmission frame, packets A1 to A6 of service A are disposed in the period of a length of six TTIs from time T=18, packets B to B3 of service B are disposed in the period of a length of three TTIs from time T=27, and packet C1 of service C is disposed in the period of a length of one TTI from time T=32. Scheduling information packet S2 is inserted in the final position.

By receiving scheduling information packet S1 of the multicast transmission frame (a), the mobile station apparatus 13 that receives either of the MBMS services of A, B and C, can ascertain the service start timing and its length (the number of TTIs) to be received in the next multicast transmission frame (b) to be transmitted, so that the user is able to receive the desired service packets. The mobile station apparatus 13 is reported of what timing the scheduling information packet is transmitted to each packet transmission apparatus 11 as advanced information, so that the mobile station apparatus 13 is able to receive MBMS service packets even while moving across cells.

In the same way, the scheduling information packet S2 that is reported to the mobile station apparatus 13 in the multicast transmission frame (b), for example, describes that packets A7 to A9 of service A will be transmitted in the period of a length of three TTIs from time T=36, that packets B4 to B6 of service B will be transmitted in the period of a length of three TTIs from time T=41, and that packet C2 of service C will be transmitted in the period of a length of one TTI from time T=50.

The packet transmission section 14 generates a multicast transmission frame (c) that reflects the content of the scheduling information packet S2 and transmits that to the mobile station apparatus 13. In other words, with this multicast transmission frame, packets A7 to A9 of service A are disposed in the periods of a length of three TTIs from time T=36, packets B4 to B6 of service B are disposed in the period of a length of three TTIs from time T=41, and packet C2 of service C is disposed in the period of a length of one TTI from time T=50, and scheduling information packet S3 is inserted in the final position. The same multicast transmission operations are repeated thereafter.

Non-patent Document 1: R2-040756 (3GPP TSG RAN2 MBMS adhoc Budapest, Hungary, 20-22 Apr. 2004)

### Non-patent Document 2: 3GPP TS Sections 25.133 8.4.2

### DISCLOSURE OF THE INVENTION

### Problems to be Solved by the Invention

However, with the W-CDMA communication system, mobile station apparatus must perform a predetermined measurement, depending on the status of the RRC (Radio Resource Control), whether MBMS services are received or not. This measurement refers to inter-frequency measurement of whether there is a W-CDMA base station of a different frequency or a base station of a communication system using other frequencies such as GSM. During the inter-frequency measurement period, a mobile station apparatus tunes the oscillator to a different frequency and therefore cannot receive MBMS service data.

For example, as disclosed in non-patent document 2, with an FDD mobile station apparatus that is in a cell FACH state and that supports both GSM and TDD reception, FDD inter-frequency measurement, TDD measurement, and GSM measurement must be performed within Tmeas ms at intervals of N_{TTI}×M_REP×10 ms.

Note that N_{TTI} is the number of the frames of the longest TTI in the SCCPCH (physical channel) monitored by the mobile station apparatus. Also, M_REP is a level measurement occasion cycle length of a different frequency specified by the host. The mobile station apparatus executes one of the FDD inter frequency measurement, TDD measurement and GSM measurement in this cycle.

Therefore, the mobile station apparatus cannot receive MBMS service data when the timing for measurement of these different levels and the timing to receive MBMS service packets overlap.

It is therefore an object of the present invention to provide a packet transmission apparatus and a packet transmission method that enable a mobile station to receive MBMS service packets that the mobile station apparatus cannot receive during level measurement of different frequencies, using current scheduling information.

### Means of Solving the Problem

The packet transmission apparatus of the present invention adopts a configuration having: an empty period searching section that searches for an empty period where no packets are accommodated, in a next multicast transmission frame in which packets of varying services transmitted from a host apparatus are disposed by time division, based on scheduling information indicating details of scheduling for the packets of varying services; a retransmission packet selection section that selects packets for an empty period as retransmission packets, from packets corresponding to a service immediately before the empty period among the packets of varying services; and a packet transmission section that disposes, in each multicast transmission frame, the packets of varying services transmitted from the host apparatus and the retransmission packets selected by the retransmission packet selection section by time division, and disposes packets for the scheduling information indicating the details of scheduling for the packets of varying services in the next frame, and transmits the each multicast transmission frame, to each mobile station apparatus.

The packet transmission method of the present invention includes: searching for an empty period where no packets are accommodated, in a next multicast transmission frame in which packets of varying services transmitted from a host apparatus are disposed by time division, based on scheduling information indicating details of scheduling for the packets of varying services; selecting packets for an empty period as retransmission packets, from packets corresponding to a service immediately before the empty period among the packets of varying services; and disposing, in each multicast transmission frame, the packets of varying services transmitted from the host apparatus and the retransmission packets selected by the retransmission packet selection section by time division, and disposing packets for the scheduling information indicating the details of scheduling for the packets of varying services in the next frame, and transmitting the each multicast transmission frame, to each mobile station apparatus.

### Advantageous Effect of the Invention

The present invention detects whether there is an empty period between different services based on current scheduling information, and, if there is an empty period, retransmits part of packets of the service transmitted just before that empty period, thereby enabling the mobile station apparatus to receive MBMS service packets that could not be received during of the level measurement of different frequencies, using the current scheduling information.

### BRIEF DESCRIPTION OF THE DRAWINGS

FIG. 1 is a diagram showing an example configuration of the conventional packet transmission apparatus;

FIG. 2 is a diagram to explain the conventional packet transmission method;

FIG. 3 is a block diagram showing a configuration of the packet transmission apparatus according to embodiment 1 of the present invention;

FIG. 4 is a diagram to explain the packet transmission method implemented by the packet transmission apparatus shown in FIG. 3;

FIG. 5 is a diagram to explain the packet transmission method implemented by the packet transmission apparatus shown in FIG. 3;

FIG. 6 is a block diagram showing a configuration of the packet transmission apparatus and wireless control apparatus according to embodiment 2 of the present invention;

FIG. 7 is a diagram to explain a counting method of a mobile station apparatus executed by the wireless control apparatus shown in FIG. 6; and

FIG. 8 is a diagram to explain the packet transmission method implemented by the packet transmission apparatus shown in FIG. 6.

### BEST MODE FOR CARRYING OUT THE INVENTION

Preferred embodiments of the present invention will now be explained in detail with reference to the drawings provided.

### Embodiment 1

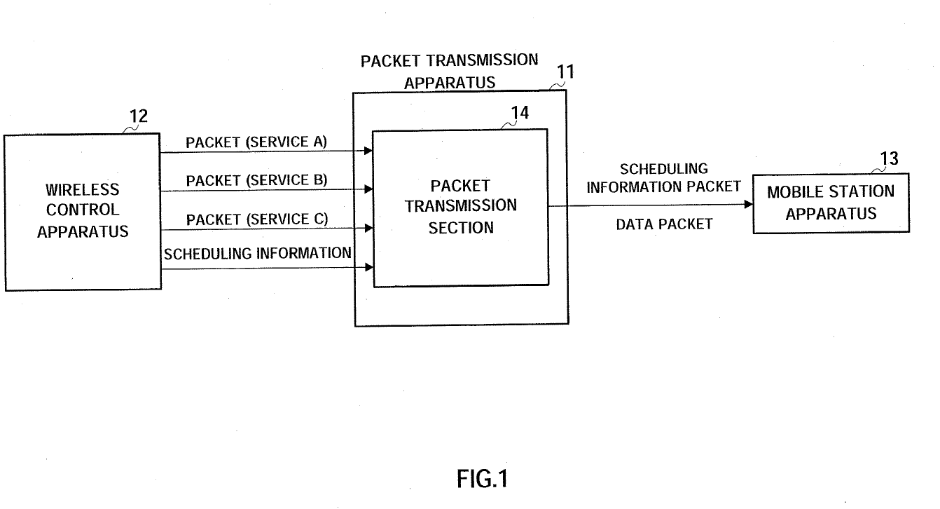

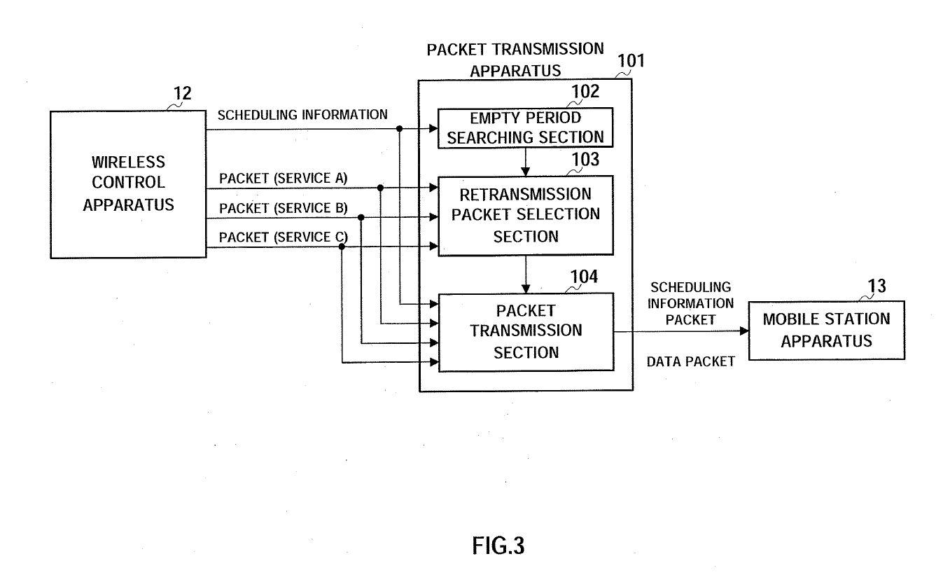

FIG. 3 is a block diagram showing a configuration of a packet transmission apparatus according to embodiment 1 of the present invention. In FIG. 3, in the MBMS service system shown as a conventional example (FIG. 1), a packet transmission apparatus 101 is provided instead of the packet transmission apparatus 11. As shown in FIG. 3 the packet transmission apparatus 101 of embodiment 1 of the present invention is equipped with an empty period searching section 102, a retransmission packet selection section 103, and a packet transmission section 104.

Scheduling information transmitted by the wireless control apparatus 12 is input to the empty period searching section 102 and the packet transmission section 104. Packets for each service transmitted by the wireless control apparatus 12 are inputted to the retransmission packet selection section 103 and the packet transmission section 104.

The empty period searching section 102 detects whether there is an empty period where there are no packets between services in the next multicast transmission frame based on scheduling information received from the wireless control apparatus 12, and, if there is an empty period, reports the length (the number of TTIs) of the empty period to the retransmission packet selection section 103.

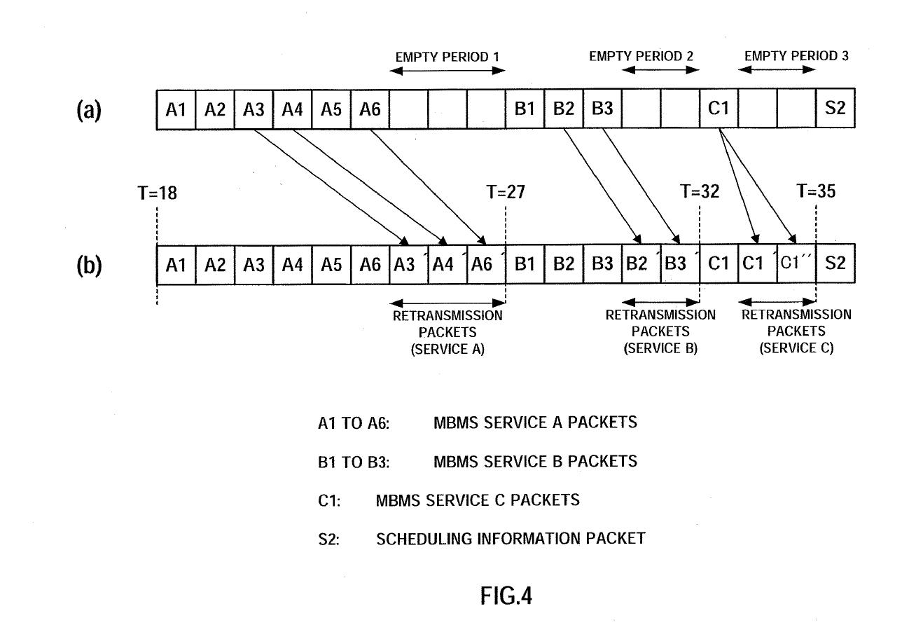

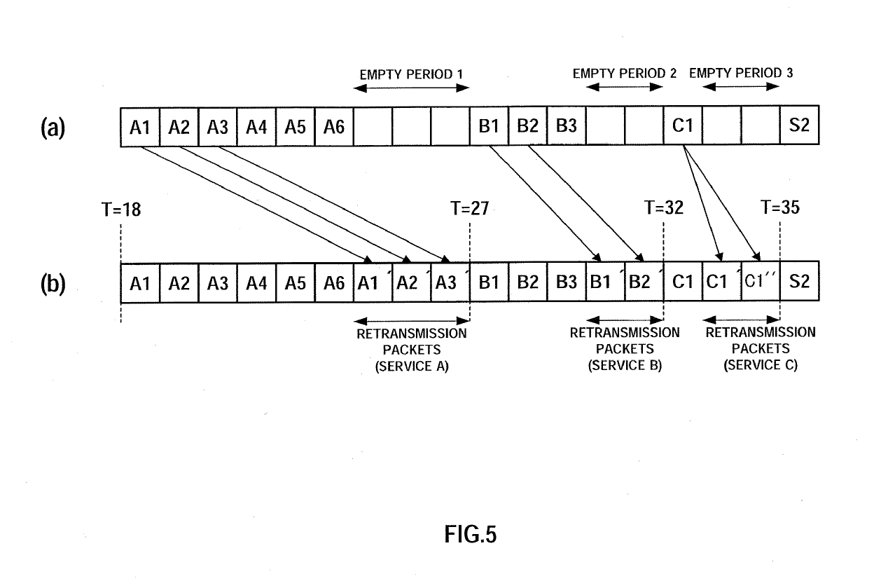

The retransmission packet selection section 103, upon receiving the search result from the empty period from the empty period searching section 102, selects as retransmission packets part of the packets corresponding to the service just before the empty period indicated by the detection result, from packets of each service (three services A, B and C in FIG. 3) inputted from the wireless control apparatus 12. There are two retransmission packet selection methods. One is shown in FIG. 4, and the other is shown in FIG. 5.

The packet transmission section 104, upon receiving scheduling information and packets of each service (three services of A, B and C in FIG. 3) from the wireless control apparatus 12, disposes data packets of service A, data packets of service B and data packets of service C by time division in a multicast transmission frame transmitted over a physical channel, based on the scheduling information in the same way as is conventional, inserts a scheduling information packet at the final position, and transmits the frame to the mobile station apparatus 13.

When doing so, according to embodiment 1, the packet transmission section 104 inserts retransmission packets for the empty period reported from the retransmission packet selection section 103, in each multicast transmission frame.

The following will now explain the operations of the packet transmission apparatus of embodiment 1 of the present invention, with references to FIGS. 3 to 5. Initially, FIG. 4 is a diagram (the first diagram) to explain the packet transmission method implemented by the packet transmission apparatus shown in FIG. 3.

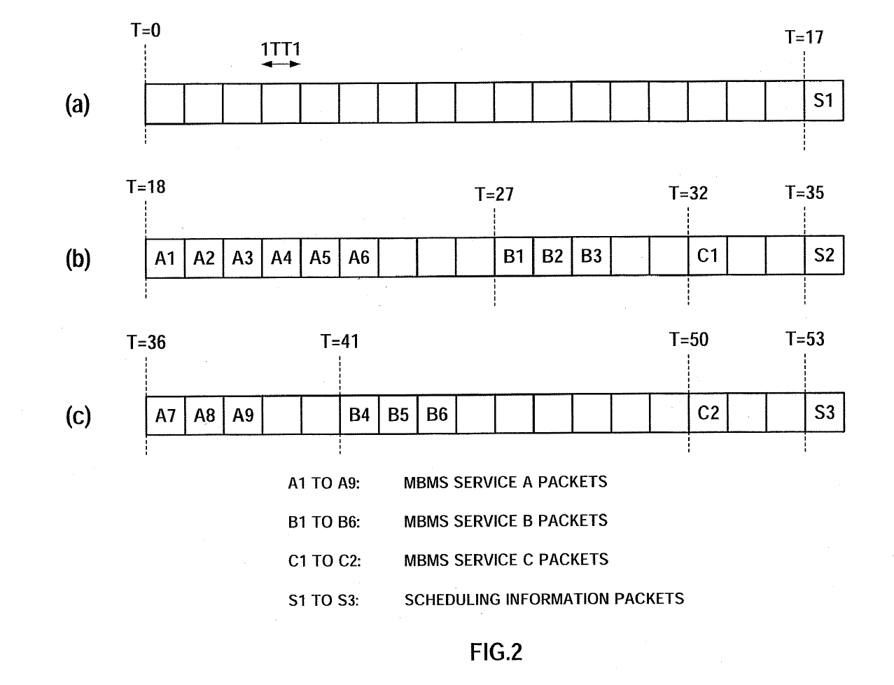

As explained in relation to FIG. 2, it is described in the scheduling information S1 that, in the period of a length of six TTIs from time T=18 packets A1 to A6 of service A will be transmitted, in the period of a length of three TTIs from time T=27 packets B1 to B3 of service B will be transmitted, and in the period of a length of one TTI from time T=32 packet C1 of service C will be transmitted.

It is obvious from FIG. 4 that there are empty periods in the multicast transmission frame (a) reflecting the scheduling information S1, namely a period of three TTIs from time T=24 (empty period 1), a period of two TTIs from time T=30 (empty period 2) and a period of two TTIs from time T=33 (empty period 3).

The empty period searching section 102, upon receiving the scheduling information S1 from the wireless control apparatus 12, detects the empty periods 1, 2 and 3 in the multicast transmission frame reflecting the scheduling information S1, as shown in FIG. 4, and reports to the retransmission packet selection section 103 that it is possible to add and transmit three TTIs of service A packets, two TTIs of service B packets, and two TTIs of service C packets.

The retransmission packet selection section 103 randomly selects packets for the amount to fill the empty periods reported from the empty period searching section 102 from packets of each service received from the wireless control apparatus 12, and reports the selected packet number to the packet transmission section 104. To explain using the example shown in FIG. 4, the third, fourth and sixth packets in service A are selected, the second and third packets in service B are selected, and one TTI of data is provided from the beginning with respect to service C, and the first packet is selected to be repeated twice, and each is reported to the packet transmission section 104.

The packet transmission section 104 fills empty period 1 by furnishing in order six TTIs of packets relating to service A from time T=18, and, by furnishing the third, fourth and sixth packets, as shown in FIG. 4, based on the scheduling information S1. In the same way, three TTIs of packets of service B are furnished from time T=27, and then the second and third packets are disposed to fill empty period 2. In the same way, when one TTI of packets of service C have been disposed at time T=32, the first packet is disposed twice, consecutively, to fill empty period 3. In this way, the multicast transmission frame (b) in which the periods of seventeen TTIs are all filled with packets, is transmitted over a physical channel.

On the other hand, the mobile station apparatus 13 is able to learn the start timing and the length (the number of TTIs) of each service from the scheduling information packet, so that the mobile station apparatus 13 is able to know in advance which services will be retransmitted in what length, without the packet transmission apparatus having to report that information separately.

Therefore, as shown in FIG. 4, a search is performed as to what services the multicast transmission frame transmitted from the scheduling information over the physical channel contains and how much empty period exists between which services, and retransmission packets are extracted from the packets transmitted for the service immediately before an empty period for retransmission to fill the empty period, so that, if packets are transmitted that the mobile station apparatus could not receive at the timing where the first packet transmission and the level measurement of different frequencies overlapped, it is possible to complement transmissions and improve throughput of the mobile station apparatus.

Next, FIG. 5 is a diagram (the second diagram) to explain the packet transmission method implemented by the packet transmission apparatus shown in FIG. 3. FIG. 5 shows a different retransmission packet selection method for the multicast transmission frame (b) than in FIG. 4. In other words, the retransmission packet selection section 103 shown in FIG. 4 randomly extracts packets to retransmit, but, as shown in FIG. 5, the retransmission packet selection section 103 constantly selects packets for the number of TTIs reported from the empty period searching section 102 in order from the top of the service to be transmitted.

The result, as shown FIG. 5, is that the packet transmission section 104 fills empty period 1 by transmitting in order six TTIs of packets relating to service A from time T=18 and by transmitting the first, second and third packets, based on the scheduling information S1. In the same way, three TTIs of packets of service B are transmitted from time T=27, and then the first and second packets are retransmitted to fill empty period 2. In the same way, when one TTI of packets of service C have been transmitted at T=32, the first packet is disposed twice, consecutively, to fill empty period 3. In this way, the multicast transmission frame (b) in which the periods of seventeen TTIs are all filled with packets, is transmitted over a physical channel.

In this way, according to the method of retransmitting data in order from the top, if any of the packets of A1, A2 or A3 is lost during the level measurement of different frequencies by the mobile station apparatus receiving service A, for example, it is possible to compensate for lost packets using retransmitted packets, and meanwhile, a mobile station apparatus that has received packets A1, A2 and A3 without error is able to determine that it needs not to receive retransmission packets, so that power consumption is reduced on that apparatus.

Furthermore, because it is ascertained in advance at the mobile station apparatus that A1, A2, and A3 are being resent without being reported in advance from the packet transmission apparatus, packets from A1 to A3 sent the first time are retained in the mobile station apparatus and after synthesis with the resent packets, they are demodulated or decoded, so it is possible to reduce the error rate of the packets.

### Embodiment 2

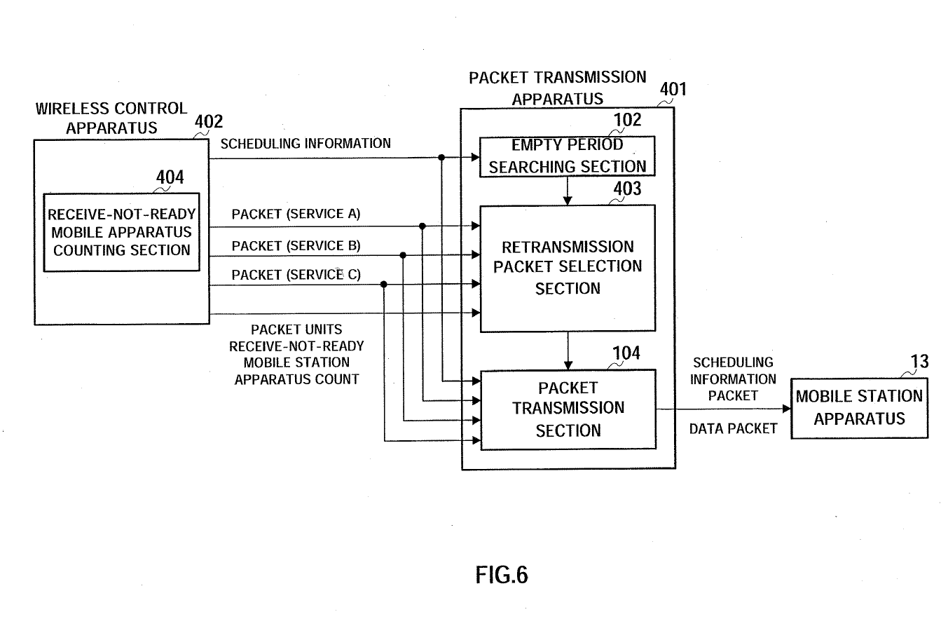

FIG. 6 is a block diagram showing a configuration of a packet transmission apparatus and a wireless control apparatus according to embodiment 2 of the present invention. Note that in FIG. 6, the same numbers are applied to components that are the same or equivalent to the components shown in FIG. 3. Therefore, the following will focus on a description of the portions relating to embodiment 2.

As shown in FIG. 6, in embodiment 2, compared to FIG. 3 (embodiment 1), a packet transmission apparatus 401 is furnished instead of the packet transmission apparatus 101, and the wireless control apparatus 402 is furnished instead of the wireless control apparatus 12.

The packet transmission apparatus 401 is furnished with a retransmission packet selection section 403 instead of the retransmission packet selection section 103, in the configuration shown in FIG. 3 (embodiment 1). Also, a receive-not-ready mobile apparatus counting section 404 is included, with the wireless control apparatus 402.

The receive-not-ready mobile apparatus counting section 404 determines whether the timing to receive packets of each mobile station apparatus receiving MBMS services for each packet transmission apparatus 401 overlaps with a measurement occasion of the levels of different frequencies, counts the number of overlapping mobile station apparatus for each packet, and gives the number of receive-not-ready mobile station apparatus that was counted, to the retransmission packet selection section 403.

When the retransmission packet selection section 403 receives the packet units of the number of receive-not-ready mobile station apparatus from the receive-not-ready mobile apparatus counting section 404, the retransmission packet selection section 403 selects the packets with the highest number of receive-not-ready mobile station apparatus from among the packets of each service that received from the wireless control apparatus 402 the number of packets to fill the empty period reported from the empty period searching section 102.

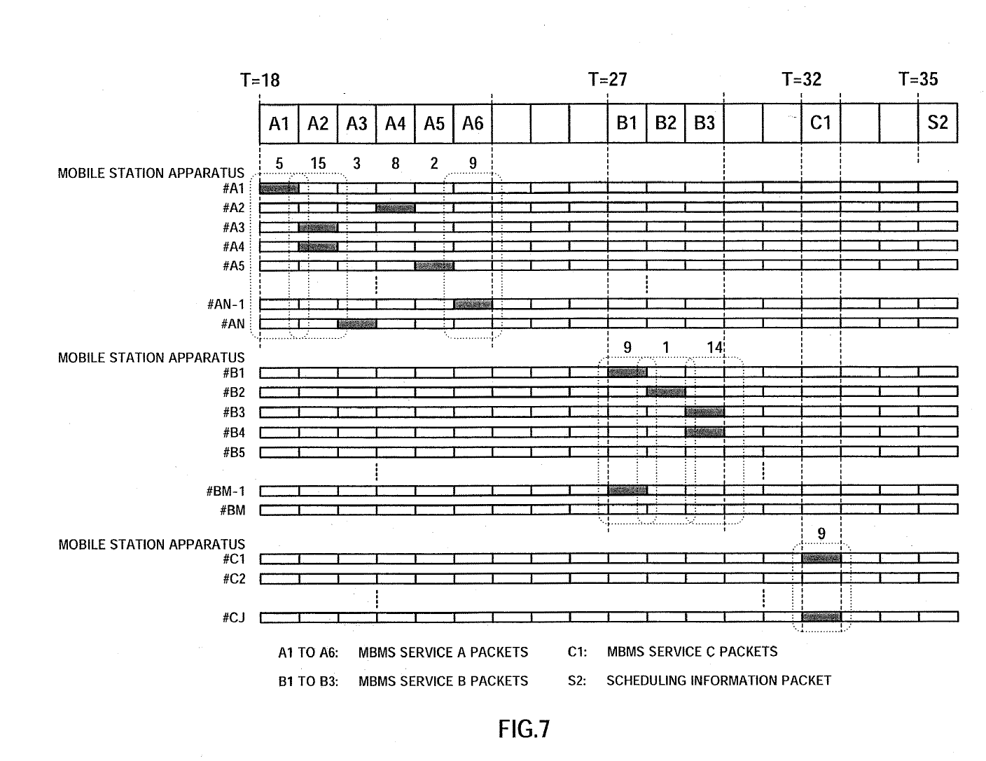

The following will now explain the operations of the packet transmission apparatus of embodiment 2 of the present invention, with references to FIGS. 6 to 8. FIG. 7 is a diagram to explain the method for counting mobile station apparatuses executed by the wireless control apparatus shown in FIG. 6.

In FIG. 7, in one packet transmission apparatus, there are N mobile station apparatuses that receive services A, M mobile station apparatuses that receive services B, and J mobile station apparatuses that receive services C.

The receive-not-ready mobile apparatus counting section 404 finds the location of the measurement occasion of the level of different frequencies for each of the N mobile station apparatuses that initially receive service A, and counts how many mobile station apparatuses there are in the period overlapping with the packet transmission interval for service A packets. In the example shown in FIG. 7, there are five mobile station apparatuses where the A1 packet transmission interval and the location of the measurement occasion of levels of different frequencies overlap, fifteen mobile station apparatuses that overlap for A2, three apparatus for A3, eight apparatus for A4, two apparatus for A5, and nine apparatus for A6.

In the same way, FIG. 7 shows that for service B, there are nine mobile station apparatuses overlapping B1, one for B2 and fourteen for B3, and that there are nine mobile station apparatuses overlapping C1 of service C. These results are reported to the retransmission packet selection section 403.

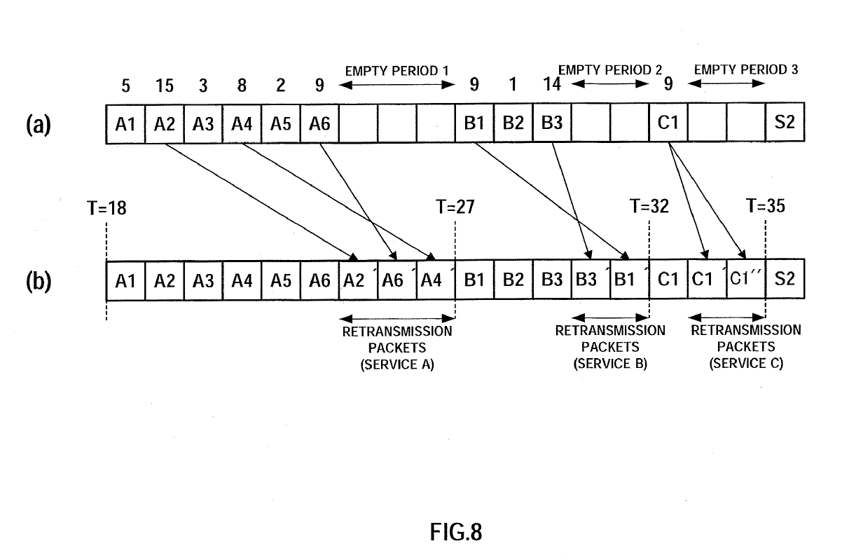

Next, FIG. 8 is a diagram to explain the packet transmission method implemented by the packet transmission apparatus shown in FIG. 6. In addition to the number of retransmissible TTIs (empty periods 1, 2, and 3) for each service reported from the empty period searching section 102 to the retransmission packet selection section 403 as explained in relation to embodiment 1, FIG. 8 shows the number of receive-not-ready mobile station apparatuses for each packet reported from the receive-not-ready mobile apparatus counting section 404.

Based on the number of retransmissible TTIs per service reported from the empty period searching section 102 and the results reported from the receive-not-ready mobile apparatus counting section 404, the retransmission packet selection section 403 selects, for each service, the packet for which the number of mobile station apparatuses that might have missed that packet is the greatest, as a retransmission packet.

In other words, in FIG. 8, the retransmission packet selection section 403 selects A2, A4 and A6 as retransmission packets because there are empty periods for three TTIs for service A, and reports these packets to the packet transmission section 104. In the same way, for service B, there are empty periods for two TTIs, so B1 and B3 are selected and reported to the packet transmission section 104. Service C only has one empty period, so this is handled in the same way as was described in relation to embodiment 1.

The order of retransmission packets transmitted by the packet transmission section 104 is arbitrary. Although there is no need to transmit retransmission packets in order from the packets of greater numbers of receive-not-ready mobile station apparatuses, FIG. 8 shows transmitting packets in order from the packets of greater numbers of receive-not-ready mobile station apparatuses.

In other words, as shown in FIG. 8, the packet transmission section 104 retransmits packets for service A in the order of A2, A6, and A4 and in the order of B3 and B1 for service B. In this way, the multicast transmission frame (b) in which the periods of seventeen TTIs are all filled with packets, is transmitted over a physical channel.

Thus, according to embodiment 2, a wireless control apparatus determines whether the timing for a measurement occasion of the levels of different frequencies for each mobile station apparatus that receives MBMS services, for each packet transmission apparatus overlaps the received MBMS packet, and reports the packet transmission apparatus of how many mobile station apparatuses were unable to receive each MBMS packet, so that the packet transmission apparatus can retransmit packets in empty periods giving priority to packets reported with the greatest count. Therefore, it is possible to save more mobile station apparatuses that were unable to receive packets during the level measurement of different frequencies.

The present application is based on Japanese patent application No. 2005-011964, filed on Jan. 19, 2005, the entire content of which is expressly incorporated herein by reference.

### INDUSTRIAL APPLICABILITY

The present invention provides a packet transmission apparatus and a packet transmission method that enable reception of MBMS service packets that could not be received during level measurements of different frequencies in a mobile station apparatus, using current scheduling information.

1. A packet transmission apparatus comprising:
an empty period searching section that searches for an empty period where no packets are accommodated, in a next multicast transmission frame in which packets of varying services transmitted from a host apparatus are disposed by time division, based on scheduling information indicating details of scheduling for the packets of varying services;
a retransmission packet selection section that selects packets for an empty period as retransmission packets, from packets corresponding to a service immediately before the empty period among the packets of varying services; and
a packet transmission section that disposes, in each multicast transmission frame, the packets of varying services transmitted from the host apparatus and the retransmission packets selected by the retransmission packet selection section by time division, and disposes packets for the scheduling information indicating the details of scheduling for the packets of varying services in the next frame, and transmits the each multicast transmission frame, to each mobile station apparatus.

2. The packet transmission apparatus according to claim 1, wherein the retransmission packet selection section selects, as the retransmission packets, packets for the empty period in order from a top of the packets corresponding to the service just before the empty period.

3. The packet transmission apparatus according to claim 1, wherein, when the number of mobile station apparatuses that were unable to receive packets in the multicast transmission frames is transmitted from a host apparatus, the retransmission packet selection section selects for the empty period a packet which a greatest number of mobile station apparatuses were unable to receive from the packets corresponding to the service just before the empty period.

4. A packet transmission method comprising the steps of:
searching for an empty period where no packets are accommodated, in a next multicast transmission frame in which packets of varying services transmitted from a host apparatus are disposed by time division, based on scheduling information indicating details of scheduling for the packets of varying services;
selecting packets for an empty period as retransmission packets, from packets corresponding to a service immediately before the empty period among the packets of varying services; and
disposing, in each multicast transmission frame, the packets of varying services transmitted from the host apparatus and the retransmission packets selected by the retransmission packet selection section by time division, and disposing packets for the scheduling information indicating the details of scheduling for the packets of varying services in the next frame, and transmitting the each multicast transmission frame, to each mobile station apparatus.

5. The packet transmission method according to claim 4, wherein, in the step of selecting the retransmission packets, packets are selected for the empty period in order from a top of the packets corresponding to the service just before the empty period.

6. The packet transmission apparatus according to claim 4, wherein, in the step of selecting the retransmission packets, when the number of mobile station apparatuses that were unable to receive packets in the multicast transmission frames is transmitted is transmitted from a host apparatus, a packet is selected which a greatest numbers of mobile station apparatuses were unable to receive from the packets corresponding to the service just before the empty period.
